(19) United States
(12) Patent Application Publication
(10) Pub. No.: US 2014/0088821 A1
(43) Pub. Date: Mar. 27, 2014

(54) METHOD AND DEVICE FOR FAULT SEARCH OF A VEHICLE

(71) Applicant: Per-Åke Nordlander, Bjästa (SE)

(72) Inventor: Per-Åke Nordlander, Bjästa (SE)

(73) Assignee: BAE Systems Hägglunds Aktiebolag, Örnsköldsvik (SE)

(21) Appl. No.: 14/119,438

(22) PCT Filed: May 16, 2012
(86) PCT No.: PCT/SE2012/050540

§ 371 Date: Nov. 21, 2013

(30) Foreign Application Priority Data
May 23, 2011 (SE) 1150481-8

(51) Int. Cl. G07C 5/00; G08B 5/00

(52) U.S. Cl. CPC G07C 5/00; G08B 5/00
USPC 701/33.2; 340/691.6

(57) ABSTRACT

The invention pertains to a method for fault search of at least one unit (a-h) of a system (100) for providing a determined technical function. The invention also pertains to a computer program product arranged to cause a computer to implement the method. The method comprises the steps of providing a visual representation displaying said system and associated units;providing in said visual representation information relating to status of at least one or more of said units in the form of actual values of at least one predetermined parameter; identifying a deviation from expected status by comparing actual values to empirically determined reference values;in a visual function representation comprising at least one likely to be defect system unit contributing to providing said status displaying a deviation from expected status, determine a defect function of such system unit by comparing in said visual function representation displayed function with correct function.

### TECHNICAL FIELD

The present invention relates to a method for fault search of at least one unit of a system for providing a determined technical function. The invention also relates to a computer program product comprising program code for a computer to implement a method according to the invention. The invention also relates to a device configured for fault search of at least one unit of a system for providing a determined technical function and a motor vehicle comprising such device, or such device that is connectable to a motor vehicle.

### BACKGROUND

Vehicles of today becomes more and more complex and therefore there is a constant need to develop existing and new methods for diagnostics, fault detection and fault localization. In cases where vehicles exhibit symptoms of that some vehicle component has an erroneous function, it is of utmost importance to rapidly be able to determine which component that is defect in order to be able to repair or exchange said defect component. Methods for locating a defect component can be applied both upon a determined symptom that indicates some form of defect functionality of the vehicle or in preventive purpose, wherein diagnostics is performed in order to minimize the risk of in a later stage being affected by operation disturbance or in worst case operation shut down.

Since the general trend for vehicles is that they become more complex fewer technicians have a complete system understanding. It becomes more and more complex to perform fault search of vehicles, this means that the cost for educating technicians and developing diagnostics tools increases.

In terms of many different vehicles fleets, such as military vehicle fleets, even in form of motorized units, it is of utmost importance to have a high availability for the vehicles included therein. This may also concern trucking firms that have a truck fleet where the vehicles in a high degree need to be available in order to be able to contribute to an efficient and lucrative business.

There is today a number of tools and methods for fault search and fault localization. Some of these will be described in brief below.

A first method for fault search of vehicles that is used today is display of signals in table format. Hereby, signals comprising information relating to parameter values for different parts of the system can be listed in table format. The parameter values can according to one example be displayed to an operator on a display screen in real time. This tool is relatively inexpensive to develop, but is nearly impossible to use for a technician having limited system understanding. The tool is primarily used for development of vehicles and is unsuitable for fault search and fault localization of fully developed vehicles and especially for time critical cases where defect components need to be located rapidly such for example during an armed conflict.

A second method for fault search of vehicles that is used today is function tree search. Function tree search is one of the most common fault search technique today. In principle no system understanding is required from a technician in order to perform the method. By methodically working through a predetermined tree structure with questions or check points a technician is able to isolate a probably defect vehicle component. However, there is a risk of providing erroneous input to the system during the method which may result in that the technician will follow a branch in the search tree that is incorrect. The method may also be associated to long fault search processing times in case the search tree is overly extensive. It is further a cost driver to develop fault search trees. An example of function tree search is described by U.S. Pat. No. 6,192,302.

A third method for fault search of vehicles that is used today is symptom driven fault search. Symptom driven fault search is a fault search method that is under development. In principle no system understanding is required from a technician in order to perform the method. A limitation associated with this method is that it is not well suited for complex vehicles where large amounts of data need to be processed. It is difficult to isolate multiple defect vehicle components. It is also a cost driver to investigate which symptom a defect vehicle component may cause. An example of a symptom driven fault search is described by EP1236986.

A fourth method for fault search of vehicles that is used today is simulation based fault search. Hereby, a deviation report with a conclusion can be generated based on a comparison between how a simulated model and a corresponding physical system reacts on a certain stimuli. In principle no system understanding is required from a technician in order to perform the method. It is a cost driver to create a model of a system that reflects the reality so well that it is useful during fault search of a vehicle. An example of a simulation based fault search is described by U.S. Pat. No. 6,226,760.

Accordingly, there is a need to provide a less cost driving, efficient and user friendly fault search method for technical system, such as for example motor vehicles.

### SUMMARY OF THE INVENTION

One object of the present invention is to provide a novel and advantageous method for fault search of at least one unit of a system for providing a determined technical function.

Another object of the present invention is to provide a novel and advantageous computer program for fault search of at least one unit of a system for providing a determined technical function.

Yet another object of the present invention is to provide a method, a device and a computer program to accomplish a more user friendly way for fault search of at least one unit of a system for providing a determined technical function.

Yet another object of the present invention is to provide a method, a device and a computer program to accomplish a more time efficient fault search of at least one unit of a system for providing a determined technical function.

Yet another object of the present invention is to provide an alternative method, a alternative device and a alternative computer program for fault search of at least one unit of a system for providing a determined technical function.

These objects are achieved by a method for fault search of at least one unit of a system for providing a determined technical function according to claim 1.

According to one aspect of the invention there is provided a method for fault search of at least one unit of a system for providing a determined technical function,

comprising the steps of
providing a visual representation displaying said system and associated units;
providing, in said visual representation, information relating to status of at least one or more of said units in the form of actual values of at least one predetermined parameter;
identifying a deviation from expected status by comparing actual values to empirically determined reference values;
in a visual function representation comprising at least one likely to be defect system unit contributing to providing said status displaying a deviation from expected status,
determining a defect function of such system unit by comparing in said visual function representation displayed function with correct function.

Hereby, is provided a user friendly method for fault search of at least one unit of a system for providing a determined technical function. Said visual representation displaying said system and units associated to the system comprising at least one system unit likely being defect that is contributing to providing said status exhibiting the deviation from expected status provides an operator with a adequate overview of the system related to a pre-selected function of the vehicle. By having a good system understanding an operator can determine a probable defect of a part of the displayed system, thereby the operator can perform a more thorough control by focusing on a subset of vehicle components displayed in the functional representation, whereby a method for fault search is provided that offers fast and secure fault localization.

On basis of having a good system understanding is possible to direct fault search towards a limited number of vehicle components which means that the time associated to performing a fault search can be minimized which in turn can provide a higher degree of availability of the vehicle. Therefore, the innovative method is cost efficient.

It should be pointed out that the innovative method can be used both on-line and off-line which achieves a method that is versatile.

The method may further comprise the steps of:
selecting said determined technical function among a number of predetermined technical functions, and
activating said visual function representation displaying said system and associated units based on said selected determined technical function.

Hereby, it is achieved that a function likely to be defect can be selected, this provides a limited amount of candidates in the form of vehicle components that are likely to be defect. For a selected function only the subsystem comprising the vehicle components that are required to realize the selected function is displayed. An experienced operator can select a function likely to be defect based on for example an identified symptom of the vehicle. Said selection may be performed based on interacting with a computer device that is used according to the innovative method.

The method may further comprise the step of:
concurrently, or alternately, displaying said representation displaying said system and associated units and said functional representation comprising at least one system unit likely to be defect. These two views can according to one example be displayed simultaneously on a computer screen. Alternatively an operator can select to sequentially display the first or second view on the computer screen. This provides a versatile solution to the above mentioned problems.

Said correct function may be a predetermined empirical function and in said visual functional representation displayed function may be a function obtained during operation.

According, to aspect of the invention there is provided a device for fault search of at least one unit of a system for providing of a determined function, comprising:
means configured to provide a visual representation displaying said system and associated units:
means configured to provide in said visual representation information relating to status of at least one or more of said units in form of actual values of at least one predetermined parameter;
means configured to enable identification of a deviation from expected status based on comparing said actual values to empirically determined reference values; and
means configured to enable in a visual functional representation comprising at least one system unit likely being defect that is contributing to providing said status exhibiting the deviation from expected status to determine a defect function of such system unit by comparing displayed function in said visual function representation with a correct function.

The device may further comprise:
means for selecting said determined technical function among a number of predetermined technical functions, and
means for activating said visual representation displaying said system and associated units based on said selected determined technical function.

The device may further comprise:
means for concurrently, or alternately, displaying said representation displaying said system and associated units and said functional representation comprising at least one system unit likely to be defect.

Of said device said correct function may be a predetermined empirical function and in said visual functional representation displayed function may be a function obtained during operation.

According to one aspect of the present invention it is provided a motor vehicle comprising a device according to the invention.

The motor vehicle may be any vehicle of a truck, bus, a military vehicle such as a tank or an armored car.

According to one aspect of the invention there is provided a computer program for fault search of at least one unit of a system for providing a technical function, said computer program comprising program code for causing an electronical computer device or another computer connected to the electronical computer device to perform the steps according to any of claims 1-4.

According to one aspect of the invention there is provided a computer program product stored on a computer readable medium for performing the method steps of any of claims 1-4, wherein said computer program is run on a electronical computer device of another computer connected to the electronical computer device.

Software comprising program code for fault search of at least one unit of a system for providing a determined technical function may easily be upgraded or exchanged. Furthermore, some parts of the software comprising program code for fault search of at least one unit for providing a determined technical function may be exchanged independently of each other. This modular configuration is beneficial from a maintenance perspective.

Additional objects, advantages and novel features of the present invention will become apparent to those skilled in the art from the following details, as well as by practice of the invention. While the invention is described below, it should be understood that the invention is not limited to the specific details disclosed. A person skilled in the art having access to the teachings herein will recognize additional applications, modifications and embodiments in other fields, which are within the scope of the invention.

### BRIEF DESCRIPTION OF THE DRAWINGS

For a more complete understanding of the present invention and further objects and advantages thereof, reference is now made to detailed description that should be read together with the accompanying drawings, wherein similar reference numerals relate to similar parts of the different drawings, and in which:

FIG. 1 schematically illustrates a vehicle, according to an aspect of the present invention;

FIG. 2 schematically illustrates a subsystem, according to an aspect of the present invention;

FIG. 3a schematically illustrates a subsystem, according to an aspect of the present invention;

FIG. 3b schematically illustrates a visual representation displaying a system and associated units, according to an aspect of the present invention;

FIG. 3c schematically illustrates a visual function representation in the form of a sequence diagram, according to an aspect of the present invention;

FIG. 4a schematically illustrates a flow chart of a method, according to an aspect of the present invention;

FIG. 4b in more detail schematically illustrates a flow chart of a method, according to an aspect of the present invention; and

FIG. 5 schematically illustrates a computer, according to an aspect of the present invention.

### DETAILED DESCRIPTION

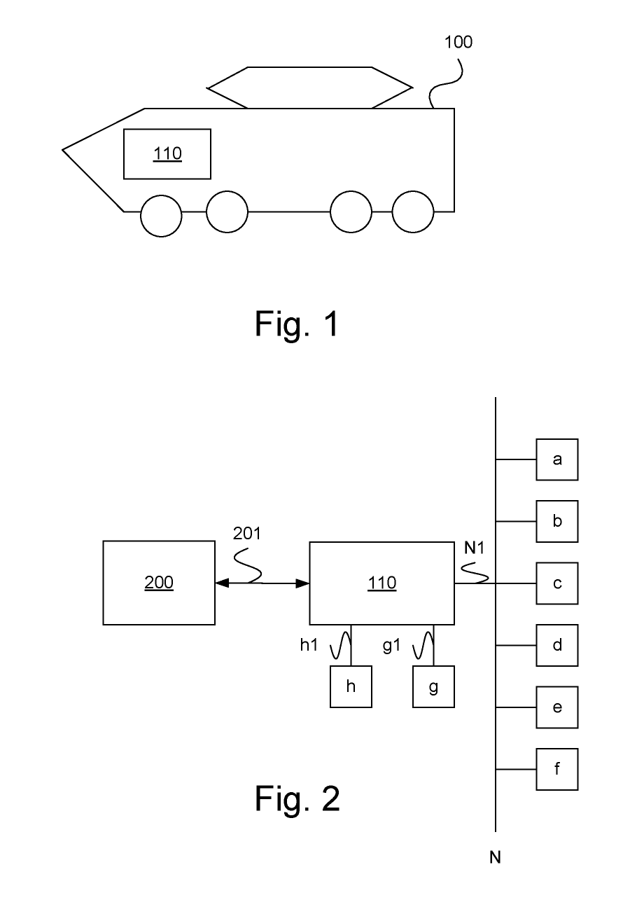

FIG. 1 schematically illustrates a vehicle 100, according to an aspect of the present invention. The vehicle 100 is preferably a motor vehicle. The vehicle 100 may be a military ground vehicle having tracks, wheels or a combination thereof.

According to one example said vehicle is a combat vehicle or a armored personnel carrier. According to one example the vehicle 100 is a tank. The vehicle comprises at least one control unit 110.

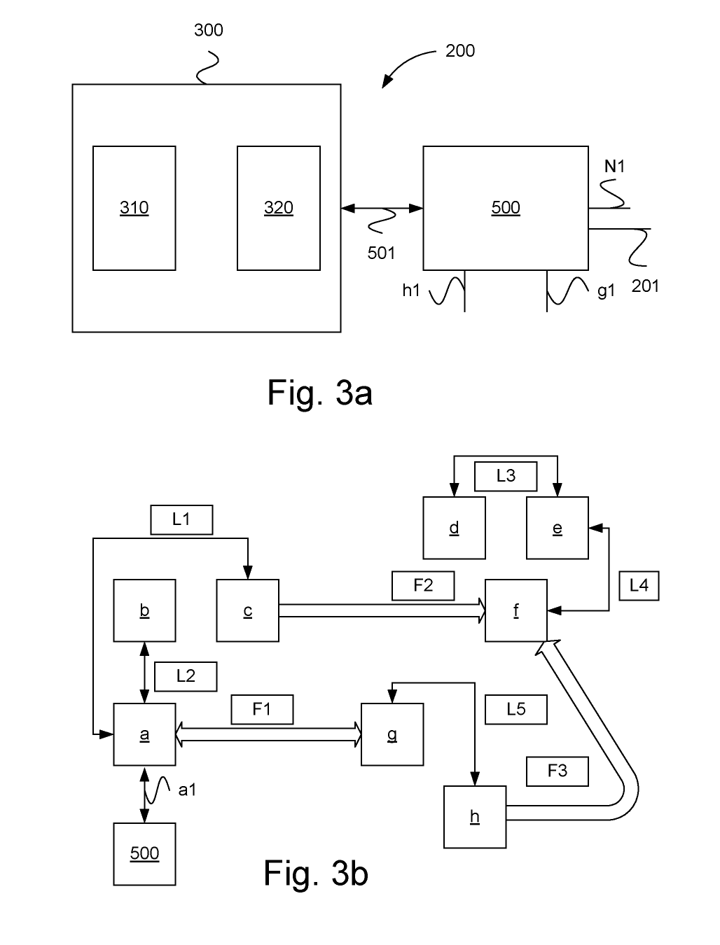

FIG. 2 schematically illustrates a subsystem, according to an aspect of the present invention.

A computer device 200 externally of the vehicle is configured for communication with the control unit 110 via a link 201. The computer device is configured for removable coupling to the control unit 110. Hereby, is the innovative method capable of being performed on-line or off-line. Thus, it is possible to transfer essential information from the control unit when the external computer device 200 is connected to the control unit 110 and thereafter perform the fault search procedure at a later point in time and eventually also on a different location.

The control unit is connected to an internal network N of the vehicle 100 via a link N1, to which network N a number of vehicle components a-h are connected. According to one option at least one of the vehicle components a-h is connected directly to the control unit 110 via a respective link. The control unit 110 may be configured for communication with the vehicle components via the internal network N or via said respective link. The control unit 110 is configured for communication with the vehicle components a-h. The control unit 110 is configured to continuously receive signals comprising relevant information from the respective vehicle component a-h, such as for example information relating to operational parameters of the vehicle in the form of actual values.

According to this example the two vehicle components g and h are directly connected to the control unit 110 via a link g1 respectively h1. According to this example the vehicle components a-g are connected to the network N via a respective link.

According to one variant of the present invention the computer device 200 and the control unit is a physical unit. According to one variant the control unit 110 is an integrated part of the computer device 200.

Herein, the term “link” refers to a communication link that may be a physical wire, such as an opto-electronicial communication cable, or a non-physical wire, such as for example a radio or microwave link.

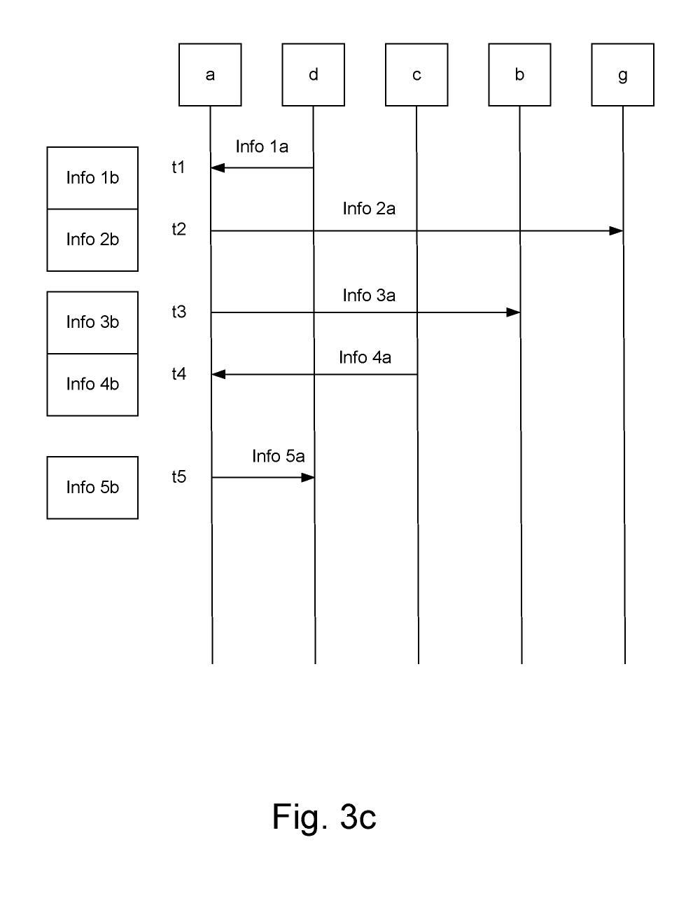

FIG. 3a schematically illustrates the computer device 200, according to an embodiment of the invention.

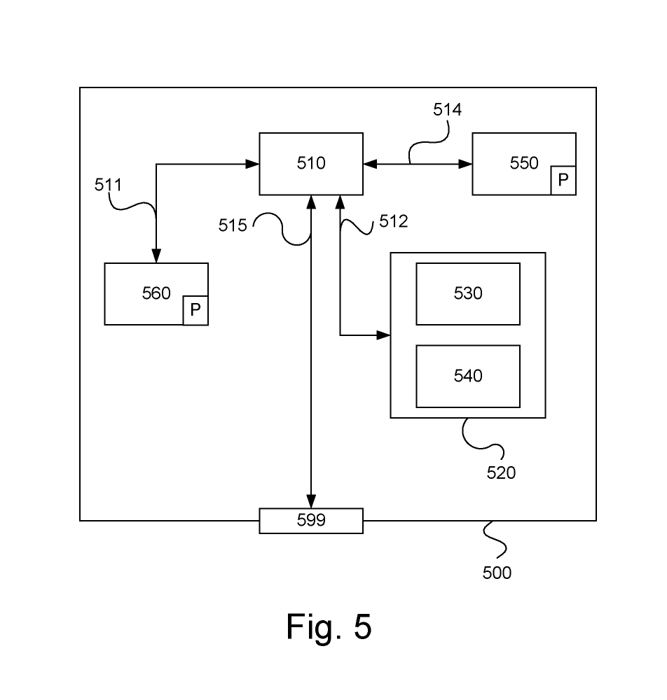

The computer device 200 comprises a data processing device 500 which is described in more detail with reference to FIG. 5. It should be pointed out that said data processing device 500 may be part of an arbitrary unit of the vehicle 100, such as for example the control unit 110 which is described with reference to FIG. 2. The computer device also comprises a display terminal 300. The data processing device 500 is configured for communication with the display terminal 300 via a link 501. The computer processing device is configured for communication with the control unit 110 via the link 201. The data processing device 500 may also be configured for communication with at least one of the vehicle components a-h via a respective link, such as for example g1 and h1 via the control unit 110 which then act as a gateway.

The display terminal 300 may be a conventional display screen. According to this example the display terminal is configured to display two information fields, namely a first information field 310 and a second information field 320. The display screen 300 may be a touch screen to enable an operator interacting with the computer device 200. Alternatively, the computer device 200 may comprise a computer mouse (not shown) to enable an operator interacting with the computer device in a conventional fashion.

FIG. 3b schematically illustrates a visual representation displaying a system and associated units, according to an embodiment of the present invention.

This visual representation is displayed in the first information field 310 of the display terminal 300 according one example of the present invention.

Hereby, a function of the vehicle 100 is illustrated. The function has been selected among a number of function of the vehicle by an operator using the computer device 200, such as for example by using the display terminal (touch screen) for activating a function of the vehicle among a number of other functions presented in a list.

Examples of functions of the vehicle may be aiming systems, weapon systems, fire control systems, ventilation systems and ramp control. The vehicle 100 may have an arbitrary number of functions. As an example the vehicle may have between 100 and 200 functions. The vehicle 100 may have fewer than 100 functions. The vehicle 100 may have more than 200 functions. According to one example all functions of the vehicle 100 are selectable for fault search. According to one example a subset of the functions of the vehicle 100 are selectable for fault search.

For each function of the vehicle 100 a predetermined number of vehicle components are included. Thereby, each function can be described by a predetermined set of vehicle components, namely those that are required in order to form said function. According to this example the vehicle components a, b, c, d, e, f, g and h form the selected function for which fault search is to be performed. Vehicle components may for example be different types of sensors, transducers or other electro-mechanical components, flow components such as for example valves, control units etc. Other examples of vehicles components may be keypads, pumps, indicators, sights and sight motors. A vehicle component may thus be an arbitrary functional element of the vehicle 100 that is part of at least one function. In cases where the vehicle component is a transducer or detector an actual value for an arbitrary operational parameter can be determined. Examples of variables of these actual values may be temperature T, pressure P, flow velocity F, current I, voltage U, rotational velocity R or vehicle velocity V.

The visual representation that display a system and associated units as selected by an operator may be displayed in different ways. One example is evident from FIG. 3b, wherein all components that form the function are illustrated in an intuitive fashion such that it becomes clear for an operator, or a technician how the different vehicle components interact. This may be realized by animating the image in order to present for example how electrical currents, or liquid flows are moving. Signal wires between different electronical vehicle components may be illustrated by simple arrows. Wires such as for example pipes for different types of liquids such as for example fuel, hydraulic oil, reducing agents may be illustrated by wider arrows.

Actual values of different components or wires of the system may be displayed in real time in the visual representation. These are indicated in FIG. 3b by the information fields L1-L5 and F1-F3, wherein the information fields L1-L5 indicates values of an electrical character, such as for example electrical current magnitude I or electrical voltage V and the information fields F1-F3 indicates signal values of flow character, such as for example flow velocity F, pressure P or temperature T of a liquid.

Hereby is also illustrated that the data processing device 500 is configured for communication with vehicle component a via the link a1. According to one exemplary embodiment the data processing device 500 is integrated in the control unit 110 (not shown in FIG. 3b). The data processing device 500 is not part of the system normal functionality.

An operator is hereby based on experience and system understanding provided in an efficient and intuitive fashion with an overview of the system that is defined by a selected function subject to fault search and may thus determine whether one or more of the vehicle components a-h, or intervening wires exhibits a deviating behavior.

According to one example it is assumed that an operator deems that one or more actual values that are displayed in the information fields L1, L2 or F1 exhibits deviating actual values for a given operations disturbance of the vehicle. According to this case the vehicles components a, b, g and the computer processing device is of interest to investigate further. According to the invention this can be performed by utilizing a visual function representation in the form of a sequence diagram, described with reference to FIG. 3c below.

FIG. 3c schematically illustrates a visual function representation in the form of a sequence diagram according to an embodiment of the present invention. Herein, are the events the units perform for the selected function. This may for example be a request of a certain information or issuance of a control command. The arrows in the sequence diagram displays how and in which sequence the units interact.

There is displayed at the arrow there which type of information that flows between the units such as for example “vehicle velocity” together with the actual values of this parameter. According to one aspect on the invention the actual values may be updated in an arbitrary frequency, such as for example 10 Hz. The sequence program may be coded using the programming language SysML. According to an alternative SysML may be used to code the activity diagram.

According to one example the sequence diagram comprises all system units that form the selected function of the vehicle 100. However, for purpose of illustration in the sequence diagram with reference to FIG. 3c only the five units of the system illustrated with reference to FIG. 3b are illustrated which are of interest for an operator to study in more detail, namely the units a, b, c, d and g.

For five different sequential points in time t1-t5 there is illustrated a respective event in the form of an arrow between two units and a determined actual value (info 1a-info 5a). According to one example an event associated with Info 2a which takes place at a second point in time t2 may comprise an actual value that is included in the information field F1 with reference to FIG. 3b. According to one example an event associated with Info 3a which may comprise an actual value that is included in the information field L2 with reference to FIG. 3b. According to one example an event associated with Info 4a which may comprise an actual value that is included in the information field L1 with reference to FIG. 3b.

For each event, that is represented by an arrow between two units, in the sequence diagram, current actual value of associated parameters is displayed (any of info 1a-info 5a). A reference value info 1b-info 5b of an associated corresponding parameter is also displayed for each event. Said actual values are predetermined actual values that adequately indicated correct functionality of the investigated function of the vehicle. Said actual values may be empirically determined such as for example during development of the vehicle. As an example according to an aspect of the invention it is determined that the actual value info 1a corresponds to and should be compared with reference value info 1b. In a similar fashion the actual value info 4a is associated with a corresponding reference value info 4b. By comparison of likewise actual value with corresponding reference value for one or more event it may be determined whether said actual value deviates abnormally from corresponding reference value.

This comparison may form the foundation based on which a determination of whether a function of a unit encompassed by an analyzed event is defect can be made. In other words an operator is able to determine a defect function of a system unit by in said visual function representation comparing displayed function (info 1a-info 5a) with correct function (info 1b-info 5b). Hereby, it is achieved a user friendly method for fault search of at least one unit of a system for providing a determined function of a vehicle. Hereby, it is achieved a user friendly method for localization of a defect of a vehicle component of a subsystem of a vehicle. The data processing device 500 monitors the communication between units and displays the result on 300.

According to one aspect of the invention the visual function representation such as the visual function representation in the form of a sequence diagram is activated based on an operator selecting a function among a number of functions of the vehicle. Said selection may be performed using components of the computer device, such as for example the display terminal 300 or by using a computer mouse for activation of a function of a number of functions displayed on the display terminal 300. As an example the sequence diagram may be displayed in the second information field 320. Accordingly, both the visual representation described with reference to FIG. 3b and the visual function representation described with reference to FIG. 3c may be activated upon a selection of a function among a number of functions of the vehicle.

According to one example the visual function representation may activated upon a selection by an operator of a subset of vehicle components required in order to form said selected function. In this example the visual function representation only display the subset of vehicle components. Said subset of vehicle components associated to a function of the vehicle may for example be selected by an operator upon noting from the visual representation with reference to FIG. 3b that one or more actual values deviates from one or more reference values. Hereby, an operator is provided with the possibility based on a noting a deviation from expected status i.e. noting that one or more actual values deviated from one or more reference values to select a subset of vehicle components for in order to perform a close inspection of said subset.

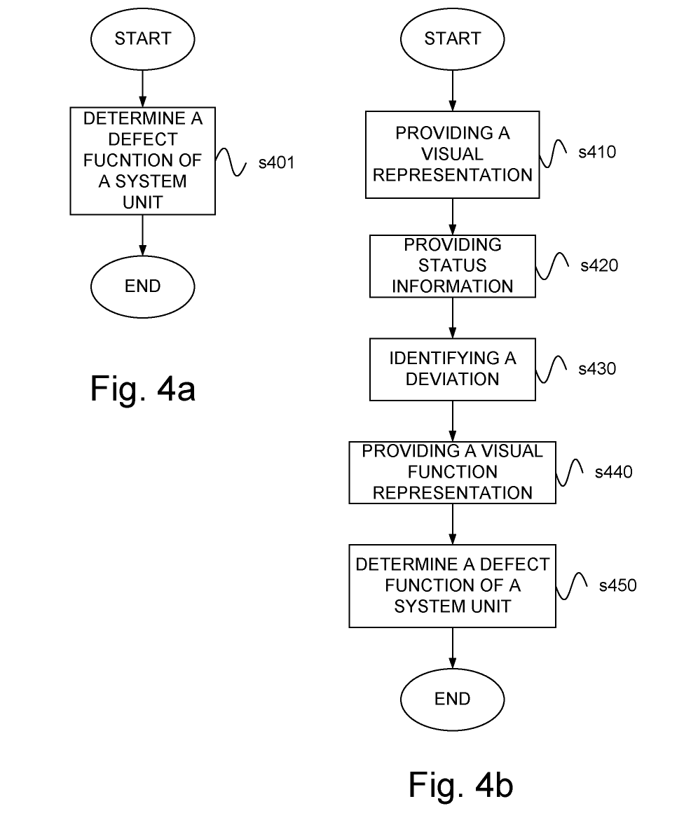

FIG. 4a schematically illustrates a flow chart of a method for fault search of at least one unit of a system for providing a determined technical function according to an embodiment of the invention. The method comprises a first method step s401. The step S401 comprises the steps of:
providing a visual representation displaying said system and associated units;
providing in said visual representation information relating to status of at least one or more of said units in form of actual values of at least one predetermined parameter;
identifying a deviation from expected status by comparing actual values with empirically determined reference values;
in a visual function representation comprising at least one system unit likely to be defect that is contributing to providing said status exhibiting the deviation from expected status,
determining a defect function of such system unit by comparing displayed function in said visual function representation with a correct function. After the step s401 the method ends.

FIG. 4b schematically in more detail illustrates a flow chart of a method for fault search of at least one unit of a system for providing a determined technical function according to an embodiment of the invention. Said system is a subsystem of the vehicle 100 formed by a selected function of the vehicle. Said function is selected by an operator of the computer device 200.

The method comprises a first method step s410. The method step s410 comprises the step of providing a visual representation displaying said system and associated units. This may be performed automatically based on a selection by an operator of the computer device 200. Said selection may be performed using components of the computer device, such as for example the display terminal 300 or by using a computer mouse for activation of a function of a number of functions displayed on the display terminal 300. After the method step s410 a subsequent method step s420 is performed.

The method step s420 comprises providing in said visual representation information relating to status of at least one or more units in the form of actual values of at least one predetermined parameter. Said providing of status may be performed by continuously displaying actual values of different units forming the selected displayed function of the vehicle. This is illustrated with reference to FIG. 3b wherein the information L1, L2, L3, L4, L5, F1, F2 and F3 is displayed. After the method step s420 a subsequent method step s430 is performed.

The method step s430 comprises the step of identifying a deviation from expected status by comparing actual values with empirically determined reference values. This is performed by an operator using experience and system understanding in order to identify a defect area of the displayed system, representing the selected function. An operator may based on experience know if one or more of the information's L1, L2, L3, L4, L5, F1, F2 and F3 deviates abnormally. In this way one or more defect units may be indentified and localized.

For example if any of the actual values L1, L2 and F1 with reference to FIG. 3b is deviating abnormally an operator may assume that there is a defect associated with the unit a. After the method step s430 a subsequent method step S440 is performed.

The method step s440 comprises the step of providing in a visual function representation comprising at least one likely to be defect system unit, contributing to providing said status deviating abnormally from expected status. An operator having according to the example above identified a possible defect of the unit may in this function representation focus on events associated with this particular unit. This visual representation is preferably a sequence diagram such as exemplified with reference to FIG. 3c. After the method step s440 a subsequent method step s450 is performed.

The method step s450 comprises the step of determining based on said visual representation a defect function of such system unit by comparing in said visual representation displayed function with correct function. By comparing in said visual function representation (sequence diagram) displayed actual values with predetermined reference values a defect function of a system unit may be determined. In case at least one of said actual value of the likely to be defect unit deviates sufficiently from a corresponding reference value an operator may determine that it is probable that the function of this particular unit is defect. After the method step s450 the method ends.

According to an aspect of the invention a method for fault search of a system 100 comprising one or more units a-h for providing one or more technical functions is provided. Each of said one or more technical functions being described by a predetermined set of units a-h of said system. The method comprises the steps of:
receiving user information relating to a selected techical function among said one or more technical functions;
providing a visual representation displaying said predetermined set of units a-h based on said selected technical function;
providing in said visual representation, information relating to status of at least one or more units of said predetermined set of units a-h in the form of actual values of at least one predetermined parameter L1, L2, L3, L4, L5, F1, F2, F3;
identifying a deviation from expected status by comparing actual values to empricially determined reference values;
providing based on said selected technical function a visual function representation displaying events that said predetermined set of units a-h performs at different sequential points in time t1-t5, said visual function representation comprising at least one likely to be defect unit a-g contributing to providing said status exhibiting a deviation from expected status, in order to enable determination of a defect function of such unit by comparing displayed function info 1a-info 5a to correct function info 1b-info 5b in the visual function representation.

With reference to FIG. 5, it is shown a diagram of configuration of an apparatus 500. The control units 200 and 210 that are described with reference to FIG. 2c may according to one configuration comprise the device 500. The apparatus 500 comprises a non-volatile memory 520. A data processing unit 510 and a read/write memory 550. The non-volatile memory 520 have a first memory element 530 wherein a computer program, such as an operating system is stored in order to control the function of the device 200.

Further, the apparatus 500 comprises a bus controller, a serial communication port, I/O-means, an ND-converter, a time date entry and transmission unit, an event counter and an interrupt controller (not shown). The non-volatile memory 520 also has a second memory portion 540.

A computer program P comprising routines for fault search of at least one unit (a-h) of a system for providing a determined technical function is provided, according to the innovative method. The program P comprises routines for providing a visual representation displaying said system and associated units. The program P comprises routines for in said visual representation providing information relating to status of one or more of said units in the form of actual values of at least one predetermined parameter. An operator may by analyzing said information relating to status indentify a deviation from expected status by comparing actual values with empirically determined reference values. The program P comprises routines for providing a visual function representation comprising at least one likely to be defect system unit contributing in providing said status displaying a deviation from expected status. An operator may determine a defect function of such system unit by comparing displayed function with correct function in said visual function representation. The program P may be stored in an executable manner or in a compressed state in a separate memory 560 and/or in read/write memory 550.

When it is stated that data processing device 510 performs a certain function it should be understood that data processing device 510 performs a certain part of the program which is stored in separate memory 560, or a certain part of the program which is stored in read/write memory 550.

Data processing device 510 may communicate with a data port 599 by means of a data bus 515. Non-volatile memory 520 is adapted for communication with data processing device 510 via a data bus 512. Separate memory 560 is adapted to communicate with data processing device 510 via a data bus 511. Read/write memory 550 is adapted to communicate with data processing device 510 via a data bus 514. The data port 599 may be connected to the links N1, 501, 201, a1, h1 and g1 (see FIGS. 2, 3a and 3b).

When data is received on data port 599 it is temporarily stored in second memory portion 540. When the received input data has been temporarily stored, data processing device 510 is set up to perform execution of code in a manner described above. According to one embodiment, data received on data port 599 comprises information related to actual values of units in a vehicle function. According to one embodiment data received on data port 599 comprises information related to parameters such as for example L1, L2, L3, L4, L5, F1, F2 and F3. The data received from the data port 599 may be used by the device 500 to display said data in the first information field 310 and in the second information field 320 in order to an operator to be able to identify a deviation from expected status by comparing actual values with empirically determined reference values and determine a defect function of such system unit by in a visual function representation comparing displayed function with correct function.

Parts of the methods described herein can be performed by apparatus 500 by means of data processing device 510 running the program stored in separate memory 560 or read/write memory 550. When apparatus 500 runs the program, parts of the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. Method for fault search of at least one unit of a system for providing a determined technical function, the method comprising the steps of:
providing a visual representation displaying said system and associated units;
providing, in said visual representation, information relating to status of at least one or more of said units in the form of actual values of at least one predetermined parameter;
identifying a deviation from expected status by comparing actual values to empirically determined reference values;
in a visual function representation comprising at least one likely to be defect system unit contributing to providing said status displaying a deviation from expected status,
determining a defect function of such system unit by comparing in said visual function representation displayed function (info 1a info 5a) with correct function.

2. Method according to claim 1, further comprising the steps of:
selecting said determined technical function among a number of predetermined technical functions, and
activating said visual representation displaying said system and associated units based on said selected determined technical function.

3. Method according to claim 1, further comprising the step of:
concurrently, or alternately, displaying said visual representation displaying said system and associated units and said function representation comprising at least one likely to be defect system unit.

4. Method according to claim 1, wherein said correct function is an empirically predetermined function and in said visual functional representation displayed function is a function obtained during operation.

5. Device for fault search of at least one unit of a system for providing a determined technical function, comprising:
means configured to provide a visual representation displaying said system and associated units;
means configured to provide in said visual representation, information relating to status of at least one or more of said units in the form of actual values of at least one predetermined parameter;
means configured to enable identification of a deviation from expected status by comparing actual values to empirically determined reference values; and
means configured to enable in a visual functional representation comprising at least one system unit likely being defect that is contributing to providing said status exhibiting the deviation from expected status to determine a defect function of such system unit by comparing displayed function in said visual function representation with a correct function.

6. Device according to claim 5, further comprising:
means for selecting said determined technical function among a number of predetermined technical functions, and
means for activating said visual representation displaying said system and associated units based on said selected determined technical function.

7. Device according to claim 5, further comprising:
means for simultaneously, or alternately, displaying said representation displaying said system and associated units a h) and said function representation comprising at least one likely to be defect system unit.

8. Device according to claim 5, wherein said correct function is an empirically predetermined function and in said visual functional representation displayed function is a function obtained during operation.

9. Motor vehicle connectable to a device according to claim 5.

10. Motor vehicle according to claim 9, wherein the motor vehicle is one of a truck, bus, car or military motor vehicle.

11. Computer program for fault search of at least one unit of a system for providing a determined technical function, wherein said computer program comprises program code for causing an electronic computer device or other computer connected to the electronic computer device to perform the steps of claim 1.

12. Computer program product comprising program code, stored on a computer readable medium, for performing the method steps according to claim 1, when said computer program is run on a electronic computer device or other computer connected to the electronic computer device.
